(19) United States
(12) Patent Application Publication
(10) Pub. No.: US 2019/0318642 A1
(43) Pub. Date: Oct. 17, 2019

(54) ONLINE PROGRAMMING EDUCATION METHOD AND SYSTEM

(71) Applicant: LILE EDUCATION AND TECHNOLOGY (SHANGHAI) CO., LTD., SHANGHAI (CN)

(72) Inventor: LUN ZHAO, SHANGHAI (CN)

(73) Assignee: LILE EDUCATION AND TECHNOLOGY (SHANGHAI) CO., LTD., SHANGHAI (CN)

(21) Appl. No.: 16/468,672

(22) PCT Filed: Oct. 10, 2017
(86) PCT No.: PCT/CN2017/105437

§ 371 Date: Jun. 11, 2019

(30) Foreign Application Priority Data
Sep. 11, 2017 (CN) 201710810718.0

(51) Int. Cl. G09B 5/14; G09B 7/02; G09B 5/06

(52) U.S. Cl. CPC G09B 5/14; G09B 5/065; G09B 7/02

(57) ABSTRACT

An online programming education method and system, comprising choosing and acquiring an online course for a piece of knowledge; and completing a programming exercise in relation to the piece of knowledge and, if the completed programming exercise meets a predetermined criterion, proceeding to an online course for another piece of knowledge next to said piece of knowledge. After the user has learnt a piece of knowledge, a programming exercise in relation thereto is provided to ensure that another piece of knowledge next to said piece of knowledge will not be made available unless the completed programming exercise meets a predetermined criterion, i.e., unless the user has mastered the piece of knowledge to some extent. Further, a teacher can use the teacher terminal to answer the user's questions in an online manner, thus enhancing his/her learning efficiency.

### TECHNICAL FIELD

The present invention relates to the field of online education and, in particular, to an online programming education method and system.

### BACKGROUND

With the overall popularity of the Internet and the increasing perfection of new educational media such as MOOC and live-streaming, more and more traditional in-person educators have turned themselves to the online education business to cater the ever-growing audience there.

The recent global trend of teaching children and young people programming has opened up a huge emerging market. However, resources in this industry are of various qualities and distributed unevenly, making it impossible to satisfy the rapidly growing demand for such education. Additionally, adolescent programming education exhibits its own unique characteristics, i.e., complicated theories, sophisticated logics, strong practice and high difficulties not only in how to encourage children's interest and help them to get started but also in how to train their computational thinking skills and ignite their creativity by means of experiential teaching and learning.

In view of this, many companies have developed a variety of products. However, none of these products can satisfactorily meet the market demand due to the following major drawbacks:

First, many existing online programming education products are video-based, and students have to learn by watching video content. In order to conduct a programming exercise during a learning course, the video clip being currently played must be manually paused first. This is extremely inconvenient to children and fails to ensure that the students can digest and absorb the imparted knowledge, due to unilateral knowledge transfer lacking interactions between the students and teacher. In addition, it is difficult for the teacher to assess learning outcomes of the students and to provide more individualized tutoring.

Secondly, it is difficult for a user, especially at an early age, to ask for help in real time when encountering a difficulty in learning programming or faced with a bug that cannot be solved by his/her own during code debugging. Even when he/she gets the answer from a resource such as the Internet, without a teacher's real-time explanations and demonstrations, the child will finally remain knowing how to solve the problem but not why the answer works, coupled with the very likely scenario that his/her parents have no knowledge of programming and could not provide any help.

While in-person programming education is immune from the above two problems, this approach is more affected by local economic conditions and local educational resources. It can only benefit children in developed cities, who account for a tiny part of the total potential audience, and is thus far from meeting the rapidly growing market demand. Moreover, it hardly allows for free choice of learning time and requires the parents to spend a lot of precious time in transporting their children between home and the learning sites and waiting for dismissal.

### SUMMARY

It is an object of the present invention to provide an online programming education method and system capable of addressing the problems with the conventional online education techniques, i.e., inability of real-time tutoring, demonstration, error correction, etc.

In order to achieve the above object, the present invention proposes an online programming education method comprising:

choosing and acquiring an online course for a piece of knowledge; and

completing a programming exercise in relation to the piece of knowledge and, if the completed programming exercise meets a predetermined criterion, proceeding to an online course for another piece of knowledge next to said piece of knowledge.

Preferably, the online programming education method may further comprise:

in the event of a question raised as to the piece of knowledge and/or the programming exercise in relation thereto, transmitting information indicating the question to a control terminal;

forwarding, by the control terminal, the information indicating the question to a teacher terminal; and

receiving, from the teacher terminal, information indicating an answer to the question.

Preferably, in the online programming education method, the information indicating the answer received from the teacher terminal may comprise any one or combination of more than one of audio data, video data, documentation data and remote control information of the teacher terminal

Preferably, in the online programming education method, educational information comprises any one or combination of more than one of audio data, video data, documentation data and remote control information.

Preferably, in the online programming education method, further comprising: setting, by the teacher terminal, attribute information for the plurality of student terminals, the attribute information comprising any one or combination of more than one of textual input-based communications, posting bans and/or incentives.

An online programming education system, comprising:

at least one student terminal, configured to choose and acquire an online course for a piece of knowledge, complete a programming exercise in relation to the piece of knowledge, if the completed programming exercise meets a predetermined criterion, proceed to an online course for another piece of knowledge next to said piece of knowledge and, in the event of a question raised as to the piece of knowledge and/or the programming exercise in relation thereto, transmit information indicating the question to a control terminal;

the control terminal, configured to receive the completed programming exercise, determine whether it meets the predetermined criterion, transmit the determination to the student terminal and forward the received information indicating the question to at least one teacher terminal; and

the at least one teacher terminal, configured to answer the question by any one of them and send information indicating the answer to the student terminal

Preferably, in the online programming education system, the online programming education system according to above method, wherein the information indicating the answer comprises any one or combination of more than one of audio data, video data, documentation data and remote control information of the teacher terminal.

Preferably, in the online programming education system, the online programming education system according to claim 7, further comprising:

a plurality of student terminals simultaneously receiving educational information from a single teacher terminal

The online programming education system according to claim 9, wherein the teacher terminal is configured to configure attribute information for the plurality of student terminals, the attribute information comprising any one or combination of more than one of textual input-based communications, posting bans and/or incentives.

Compared with the prior art, the beneficial effects of the present invention lie primarily in that, after the user has learnt a piece of knowledge, a programming exercise in relation thereto is provided to ensure that another piece of knowledge next to said piece of knowledge will not be made available unless the completed programming exercise meets a predetermined criterion, i.e., unless the user has mastered the piece of knowledge to some extent. Further, a teacher can use the teacher terminal to answer the user's questions in an online manner, thus enhancing his/her learning efficiency.

### BRIEF DESCRIPTION OF THE DRAWINGS

FIG. 1 is a flowchart of an online programming education method according to an embodiment of the present invention.

FIG. 2 is a structural schematic of an online programming education system according to an embodiment of the present invention.

### DETAILED DESCRIPTION

An online programming education platform according to the present invention will be described in greater detail below with reference to the appended schematic drawings.

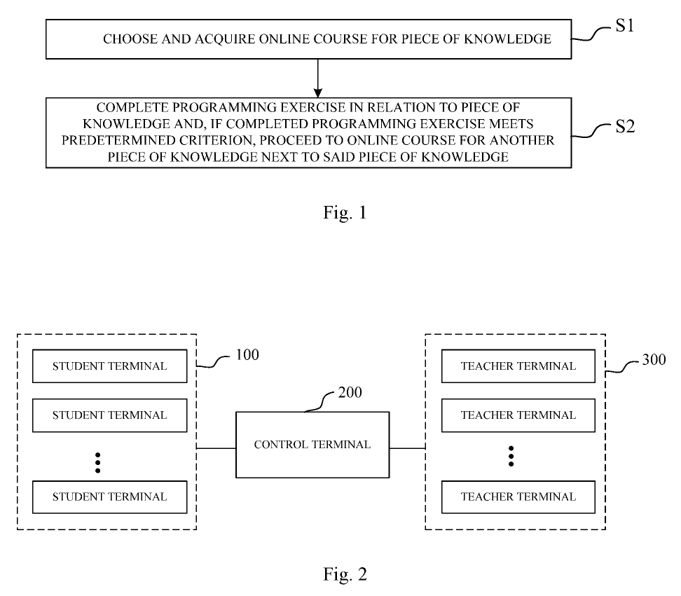

In an embodiment of the present invention, there is provided an online programming education method. Reference is now made to FIG. 1, a flowchart of an online programming education method according to an embodiment of the present invention. Specifically, the online programming education method includes: choosing and acquiring an online course for a piece of knowledge, as shown in step S1 in FIG. 1; and completing a programming exercise in relation to the piece of knowledge and, if the completed programming exercise meets a predetermined criterion, proceeding to an online course for another piece of knowledge next to said piece of knowledge, as shown in step S2 in FIG. 1.

In step S1, an online course for a piece of knowledge is chosen and acquired. On a control terminal, there may be multiple learning curriculums which are composed of instructional videos and programming exercises and are of different levels integrated coherently and shifting in an automated manner.

With a student terminal, an online course for a piece of knowledge may be chosen from one of the learning curriculums on the control terminal In an embodiment herein, the online course may include, but is not limited to, video information. In other words, a user may use the student terminal to choose a video clip about the piece of knowledge from the learning curriculum on the control terminal.

Further, the user's choice of the video clip about the piece of knowledge may be made either at his/her own discretion or following an arrangement made available by a teacher on a teacher terminal.

After the user has finished watching the video about the piece of knowledge, the control terminal may prompt the user to practice a related programming exercise.

If the user has any question as to the piece of knowledge while watching the video thereabout, he/she can transmit information indicating the question to the control terminal In response to receipt of the information indicating the question, the control terminal may forward it to at least one teacher terminal

Any of the at least one teacher terminal may answer the question, i.e., providing the student terminal with information indicating the answer. The information may include, but is not limited to, any one or combination of more than one of audio data, video data, documentation data and remote control information of the teacher terminal.

Specifically, upon receiving the information indicating the question, the teacher terminal may respond and answer the question in real time either by voice or directly by a video call based on a video connection established with the student terminal This can improve the efficiency of communication and facilitate the user's understanding of the piece of knowledge.

In step S2, a programming exercise in relation to the piece of knowledge is completed, and if the completed programming exercise meets a predetermined criterion, the method proceeds to an online course for another piece of knowledge next to the aforesaid piece of knowledge.

The user may use the student terminal to complete the programming exercise in relation to the piece of knowledge, and if the predetermined criterion is met or if a learning objective is achieved, the method will proceed to the online course for the other piece of knowledge next to the completed piece of knowledge. In this way, the user can gradually master the content of the courses step by step.

In an embodiment of the present invention, the predetermined criterion may include, but is not limited to, a grammatical error rate that is not higher than a predetermined value. The predetermined value may be either a fixed value, or set by the teacher terminal based on a level of difficulty of the piece of knowledge, which takes into account a completion rate of other pieces of knowledge, e.g., whether the involved other pieces of knowledge are mandatory or not.

If the user has any question in the course of performing the programming exercise in relation to the piece of knowledge at the student terminal, he/she can send information indicating the question to the control terminal. In this case, the information indicating the question is related to the programming exercise. Of course, in addition to the programming exercise, the information may also be related to the piece of knowledge.

After receiving the information indicating the question, the control terminal may forward it to any of the at least one teacher terminal to allow the latter to answer the question.

Similarly to how the question about the piece of knowledge is answered, the teacher terminal can answer the question about the programming exercise in any of various manners. For example, the teacher may use the teacher terminal to provide the user of the student terminal with voice-based tutoring in which the question from the user is explained by voice.

In another embodiment of the present invention, the teacher and the user may establish a video connection between the teacher terminal and the student terminal so that the teacher can answer the user's question by video. In this process, the teacher can directly give a whiteboard presentation, just like in an actual classroom, so that the user can receive the teacher's guide more intuitively and learn more efficiently.

In yet another embodiment of the present invention, the teacher can use the teacher terminal to directly transmit the information indicating the answer to the question to the student terminal The information indicating the answer may include, but is not limited to, a code in relation to the question.

In still another embodiment of the present invention, the teacher can use the teacher terminal to remotely control the student terminal so as to directly answer the question at the student terminal and, in particular, directly apply a modification, annotation or explanation to the programming exercise completed by the user. In this way, the user can view and understand the answer more clearly. Further, higher individualization can be achieved than in an actual classroom, which can not only increase the user's learning performance but also improve his/her learning experience.

In a further embodiment of the present invention, the teacher can use the teacher terminal to divide users into classes. In other words, a plurality of student terminals may be all connected to a common teacher terminal so that the teacher terminal can broadcast educational information simultaneously to the plurality of student terminals.

In case the teacher uses the teacher terminal to deal with a plurality of users, this can be done in any of various manners. For example, the teacher can interact simultaneously with all of the users by voice, and the users may also be allowed to directly interact by voice.

In a further embodiment of the present invention, the teacher may interact with the plurality of users based on a video connection established between the teacher terminal and the student terminals. In this process, the teacher can give a whiteboard presentation in real time, making it possible for the plurality of users to more clearly understand what the teacher has taught.

In a further embodiment of the present invention, in the voice- or video-based educational activities of the teacher, he/she can also send educational content to the student terminals of the plurality of users in the form of codes.

In the event that any user comes up with a question, the teacher can provide individualized tutoring and answering by directly writing a code at the user's student terminal through remote control. This can enhance learning efficiency and performance and improve user experience.

It should be noted that, in embodiments of the present invention, approaches that can be used by the teacher for teaching may include, but are not limited to, voice teaching, video teaching, delivery of codes and remote code editing. In practical applications, other approaches may also be used. Of course, any effective combination of these approaches is also suitable but will not be described herein in the interest of brevity.

In another embodiment of the present invention, the teacher terminal may be configured so as to allow textual input-based communications between the student terminals of the plurality of users. Of course, in other embodiments of the present invention, the teacher terminal may also be configured to set attributes of the individual student terminals connected thereto. For example, a certain one of the student terminals may be allowed for textual exchanges, while another student terminal is banned for posting, i.e., disabled for textual communications. Of course, incentives and praises for the users are also possible.

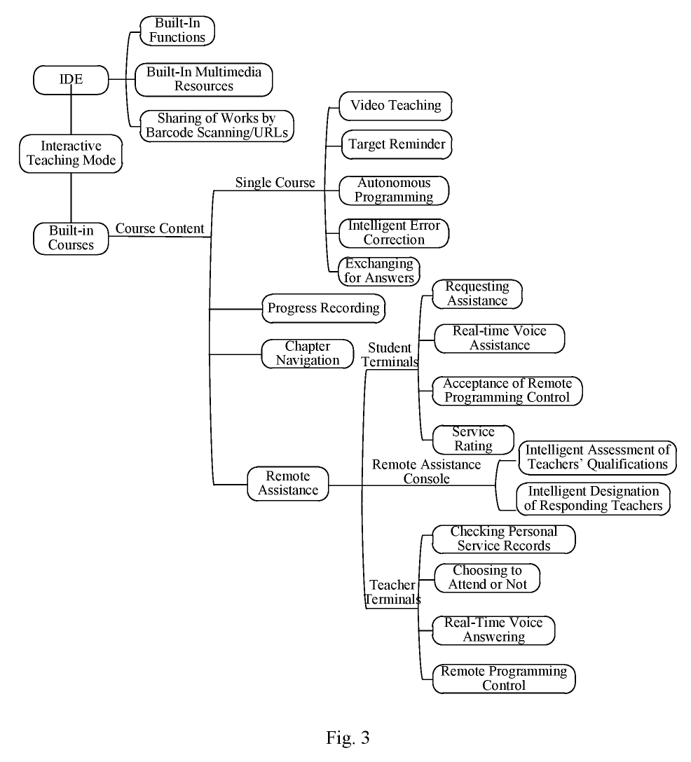

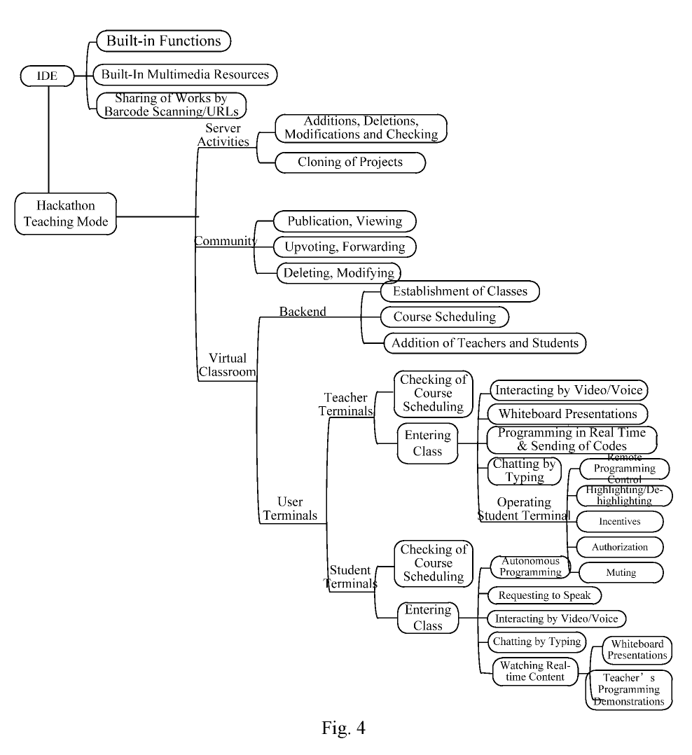

The present invention also provides an online programming education system. Reference is now made to FIG. 2, a structural schematic of an online programming education system according to an embodiment of the present invention. The online programming education system includes at least one student terminal 100, at least one teacher terminal 300 and a control terminal 200.

Before a user starts to learn programming with the online programming education system, the system may automatically verify hardware configurations of the student terminal 100 for the user and the teacher terminal 300 for a teacher and determine a communications scheme between the student terminal 100 and the teacher terminal 300 based on the verification.

Subsequently, the user can begin to learn programming with the online programming education system. Specifically, the control terminal 200 may first send pre-course test information to the at least one student terminal 100. The user is required to complete the pre-course test, and the control terminal 200 may assess and know his/her knowledge level based on the completed pre-course test.

Afterward, with the at least one student terminal 100, an online course for a piece of knowledge may be chosen and obtained and a programming exercise in relation to the piece of knowledge may be completed, followed by submission of the completed programming exercise to the control terminal 200. Upon receipt of the programming exercise, the control terminal 200 may determine whether the completed programming exercise meet a predetermined criterion and feed the determination back to the student terminal 100. If the completed programming exercise meets the predetermined criterion, the student terminal 100 may be guided to an online course for another piece of knowledge next to the aforementioned piece of knowledge.

After the user has completed the learning of the piece of knowledge, with the completed programming exercise meeting the predetermined criterion, and before the other piece of knowledge next to said piece of knowledge, the control terminal 200 may send post-course test information to the user's student terminal 100. The user is required to complete the post-course test, and the control terminal 200 may assess his/her knowledge level subsequent to the learning of the piece of knowledge based on the completed post-course test and verify his/her learning outcome by comparing this knowledge level with that prior to the learning of the piece of knowledge.

Further, the control terminal 200 may maintain a management file for each user, which records details in his/her learning of all pieces of knowledge, the completion of programming exercises associated with the pieces of knowledge, the completion of pre-course tests for the pieces of knowledge, the completion of post-course tests for the pieces of knowledge and learning outcomes of the pieces of knowledge. The teacher can track the learning of any user by accessing his/her management file on the control terminal 200 and, based thereon, propose suggestions for his/her subsequent learning plan. This allows increased pertinence of the user's learning and further improves his/her learning performance.

Further, in the event of a question raised from any student terminal 100 as to the piece of knowledge and/or the programming exercise in relation thereto, information indicating the question may be transmitted to the control terminal 200. Upon receiving the information indicating the question, the control terminal 200 may forward it to the at least one teacher terminal 300. Any of the at least one teacher terminal 300 may answer the question and feed information indicating the answer back to the student terminal 200.

The user may evaluate the teacher with his/her student terminal 100. The teacher may include, but is not limited to, the one who has answered the question from the user. The user may also give a feedback about the answer provided by the teacher in order to assess the teacher's teaching level. The control terminal 200 may rate the teacher based on the user's evaluation and feedback.

In a further embodiment of the present invention, the control terminal 200 may provide the user's knowledge levels before and after he/she learns the piece of knowledge and a comparison therebetween to the at least one teacher terminal 300 so that the teacher can know the user's knowledge levels and learning outcome via the teacher terminal 300.

Furthermore, the teacher may use the teacher terminal 300 to acquire the learning outcomes of a plurality of users in a single course and, based thereon, determine the appropriateness of the course. If the course is determined to be inappropriate, it may be optimized on the same basis in order to further improve the users' learning outcomes.

The online programming education system according to this embodiment may include two teaching modes: interactive and hackathon. Both of the interactive and hackathon teaching modes may be implemented in an integrated development environment (IDE) built in with multiple callable functions and multimedia resources and allowing barcode scanning and sharing of URLs and works.

Specifically, as shown in FIG. 3, in the interactive teaching mode, a student may choose a single course to learn, which includes video teaching, and from which the student can learn how to set a target reminder and how to perform autonomous programming The course may also include other means, such as intelligent error correction and exchanging for answers, for ensuring that the student can eventually gain a full understanding of the course. In addition, the interactive teaching mode may be equipped with the functions of progress recording and chapter navigation, in order to help the student directly resume learning from the node where he/she left off last time when re-entering the system and help the student jump between chapters as desired. The interactive teaching mode also includes remote assistance equipped with student terminals, a remote assistance console and teacher terminals. Each student terminal can launch requests for assistance during learning, including those for real-time voice assistance, and accept remote programming control which allows a teacher to conduct real-time control and rectification activities. Moreover, the student is allowed to rate the teacher's services. The remote assistance console may have the capabilities including intelligent assessment of teachers' qualifications and intelligent designation of teachers to respond to students' requests for assistance. Each teacher terminal may have the capabilities including checking personal service records, choosing to attend or not, real-time voice answering and remote programming control which is intended principally to allow the teacher to conduct programming control and rectification activities for students so as to provide them with comprehensive real-time tutoring.

As shown in FIG. 4, the hackathon teaching mode allows server activities such as additions, deletions, modifications and checking of programming works of interest and cloning of programming projects. Moreover, programming works may be published in a community to allow learners to exchanges their opinions thereon, and may be viewed, upvoted, forwarded, deleted, modified or otherwise updated. The hackathon teaching mode may further include a virtual classroom allowing establishment of classes, course scheduling and addition of teachers and students at the backend. As a user terminal of the virtual classroom, a teacher terminal allows a teacher to check the course scheduling and, when in a class, interact by video or voice, make whiteboard presentations, program in real time, send codes, chat by typing text messages, operate a student terminal (e.g., remote programming control), highlight or de-highlight a student terminal for its whiteboard presentations, offer incentives for students, mute a student terminal, authorize a student to speak or perform other operations. A student may use the student terminal to check the course scheduling and, when in a class, practice autonomous programming, request to speak, interact by video or voice, chat by typing text messages and watch real-time content sent from the teacher, including whiteboard presentations, the teacher's programming demonstrations, etc.

The online programming education method using this online programming education system has been described above and will not be detailed further here. The educational content involved in teaching activities is subject to no limitation, and any programming language such as C, C++, Java or the like may be used in the online education.

In embodiments of the present invention, the control terminal includes, but is not limited to, a server.

In summary, in the online programming education method and system provided in embodiments of the present invention, after the user has learnt a piece of knowledge, a programming exercise in relation thereto is provided to ensure that another piece of knowledge next to said piece of knowledge will not be made is available unless the completed programming exercise meets a predetermined criterion, i.e., unless the user has mastered the piece of knowledge to some extent. Further, a teacher can use the teacher terminal to answer the user's questions in an online manner, thus enhancing his/her learning efficiency.

1. An online programming education method, comprising:
choosing and acquiring an online course for a piece of knowledge; and
completing a programming exercise in relation to the piece of knowledge and, if the completed programming exercise meets a predetermined criterion, proceeding to an online course for another piece of knowledge next to said piece of knowledge.

2. The online programming education method according to claim 1, further comprising:
in the event of a question raised as to the piece of knowledge and/or the programming exercise in relation thereto, transmitting information indicating the question to a control terminal;
forwarding, by the control terminal, the information indicating the question to a teacher terminal; and
receiving, from the teacher terminal, information indicating an answer to the question.

3. The online programming education method according to claim 2, wherein the information indicating the answer received from the teacher terminal comprises any one or combination of more than one of audio data, video data, documentation data and remote control information of the teacher terminal

4. The online programming education method according to claim 2, further comprising:
simultaneous receipt of educational information by a plurality of student terminals from a single teacher terminal

5. The online programming education method according to claim 4, wherein the educational information comprises any one or combination of more than one of audio data, video data, documentation data and remote control information.

6. The online programming education method according to claim 5, further comprising:
setting, by the teacher terminal, attribute information for the plurality of student terminals, the attribute information comprising any one or combination of more than one of textual input-based communications, posting bans and/or incentives.

7. An online programming education system, comprising:
at least one student terminal, configured to choose and acquire an online course for a piece of knowledge, complete a programming exercise in relation to the piece of knowledge, if the completed programming exercise meets a predetermined criterion, proceed to an online course for another piece of knowledge next to said piece of knowledge and, in the event of a question raised as to the piece of knowledge and/or the programming exercise in relation thereto, transmit information indicating the question to a control terminal;
the control terminal, configured to receive the completed programming exercise, determine whether it meets the predetermined criterion, transmit the determination to the student terminal and forward the received information indicating the question to at least one teacher terminal; and
the at least one teacher terminal, configured to answer the question by any one of them and send information indicating the answer to the student terminal

8. The online programming education system according to claim 7, wherein the information indicating the answer comprises any one or combination of more than one of audio data, video data, documentation data and remote control information of the teacher terminal.

9. The online programming education system according to claim 7, further comprising:
a plurality of student terminals simultaneously receiving educational information from a single teacher terminal

10. The online programming education system according to claim 9, wherein the teacher terminal is configured to configure attribute information for the plurality of student terminals, the attribute information comprising any one or combination of more than one of textual input-based communications, posting bans and/or incentives.
